(19) United States
(12) Patent Application Publication
(10) Pub. No.: US 2026/0367675 A1
(43) Pub. Date: Nov. 19, 2026

(54) ELECTRONIC DEVICE

(71) Applicant: COMPAL ELECTRONICS, INC., Taipei City (TW)

(72) Inventors: Kuan-Chang Lee, Taipei City (TW); Tung-Ying Wu, Taipei City (TW); Chao-Chen Lu, Taipei City (TW); Hsin Chen, Taipei City (TW); Wang-Hung Yeh, Taipei City (TW)

(73) Assignee: COMPAL ELECTRONICS, INC., Taipei City (TW)

(21) Appl. No.: 19/461,671

(22) Filed: Jan. 27, 2026

Related U.S. Application Data
(60) Provisional application No. 63/804,679, filed on May 13, 2025.

(51) Int. Cl. G06F 1/16

(52) U.S. Cl. CPC G06F 1/1681

(57) ABSTRACT

An electronic device including a display host, a logic host, a hinge module, and a latching module movably assembled to the logic host and connected to the hinge module to lock or unlock the hinge module is provided. The hinge module is connected between the display host and the logic host, and the display host and the logic host pivot relative to each other via the hinge module to fold or unfold. When locked, the latching module blocks pivoting of the hinge module; when unlocked, the latching module releases the hinge module to allow the hinge module to pivot. After the display host pivots relative to the logic host via the hinge module to unfold, the electronic device is driven by a triggering action to drive the latching module to lock the hinge module or release the hinge module.

### CROSS-REFERENCE TO RELATED APPLICATION

This application claims the priority benefit of U.S. provisional application serial no. 63/804,679, filed on May 13, 2025. The entirety of the above-mentioned patent application is hereby incorporated by reference herein and made a part of this specification.

### BACKGROUND

### Technical Field

The disclosure relates to an electronic device.

### Description of Related Art

In existing laptops, in order to enhance user operability, the hinge is typically designed with a relatively low torque value, so that a user may apply force to the display host with one hand, or even with a single finger of one hand, to convert the device from a closed state (in which the display host is superposed upon the logic host) to an open state (in which the display host is unfolded relative to the logic host).

However, the foregoing design entails additional risks. For example, with an increase in usage modes, in addition to the basic function of pivotal opening and closing relative to the logic host, once unfolded relative to the logic host the display host may further switch between a landscape state and a portrait state by means of a second-axis pivot mechanism (the aforementioned pivot relative to the logic host being regarded as a first-axis pivot mechanism). When the display host is in the portrait state, its center of gravity is markedly higher than when in the landscape state, thereby imposing a burden on the torque design of the first-axis pivot mechanism.

Moreover, the display host commonly incorporates touch functionality; accordingly, when a user applies force to the display host during touch input, the display host is readily driven to change its angle relative to the logic host. This not only tends to cause erroneous touch inputs and functional failure of the touch-enabled display host, but also alters the originally appropriate viewing angle, thereby causing inconvenience in use.

In view of the foregoing, how to accommodate both of the above-described usage requirements—namely, enabling single-handed opening and closing of the display host and maintaining stability of the display host during touch input—constitutes a technical problem that those skilled in the art must consider and overcome.

### SUMMARY

An electronic device that may change the state of the hinge module according to usage requirements is provided in the disclosure.

The disclosure relates to an electronic device, which includes a display host, a logic host, a hinge module, and a latching module. The hinge module is connected between the display host and the logic host, and the display host and the logic host pivot relative to each other via the hinge module to fold and unfold. The latching module is movably assembled to the logic host and connected to the hinge module to lock or unlock the hinge module. When locked, the latching module blocks pivoting of the hinge module. When unlocked, the latching module releases the hinge module to allow the hinge module to pivot. After the display host pivots relative to the logic host via the hinge module to unfold, the electronic device is driven by a triggering action to drive the latching module to lock the hinge module or release the hinge module.

Based on the above, the electronic device provides different driving modes for locking or unlocking the hinge module through a latching module disposed in the logic host and connected to the hinge module. When locked, the latching module blocks pivoting of the hinge module. When unlocked, the latching module releases the hinge module, allowing the display host and logic host to pivot relative to each other via the hinge module to fold and unfold. The aforementioned driving modes are executed by an externally triggering action after the display host unfolds relative to the logic host. Accordingly, users may adjust the locked or unlocked state of the hinge module according to their usage requirements.

### BRIEF DESCRIPTION OF THE DRAWINGS

FIGS. 1A and 1B respectively illustrate different states of an electronic device of the disclosure.

FIG. 2 is an exploded schematic diagram of some components of the electronic device.

FIGS. 3A-3C respectively illustrate different states of a latching module.

FIG. 3D is an exploded schematic diagram of the latching module.

FIGS. 4A and 4B respectively illustrate the corresponding states of a clutch and the electronic device.

FIG. 5A is a schematic diagram of a latching module of another embodiment of the disclosure.

FIG. 5B illustrates some components of FIG. 5A from another perspective.

### DETAILED DESCRIPTION OF DISCLOSED EMBODIMENTS

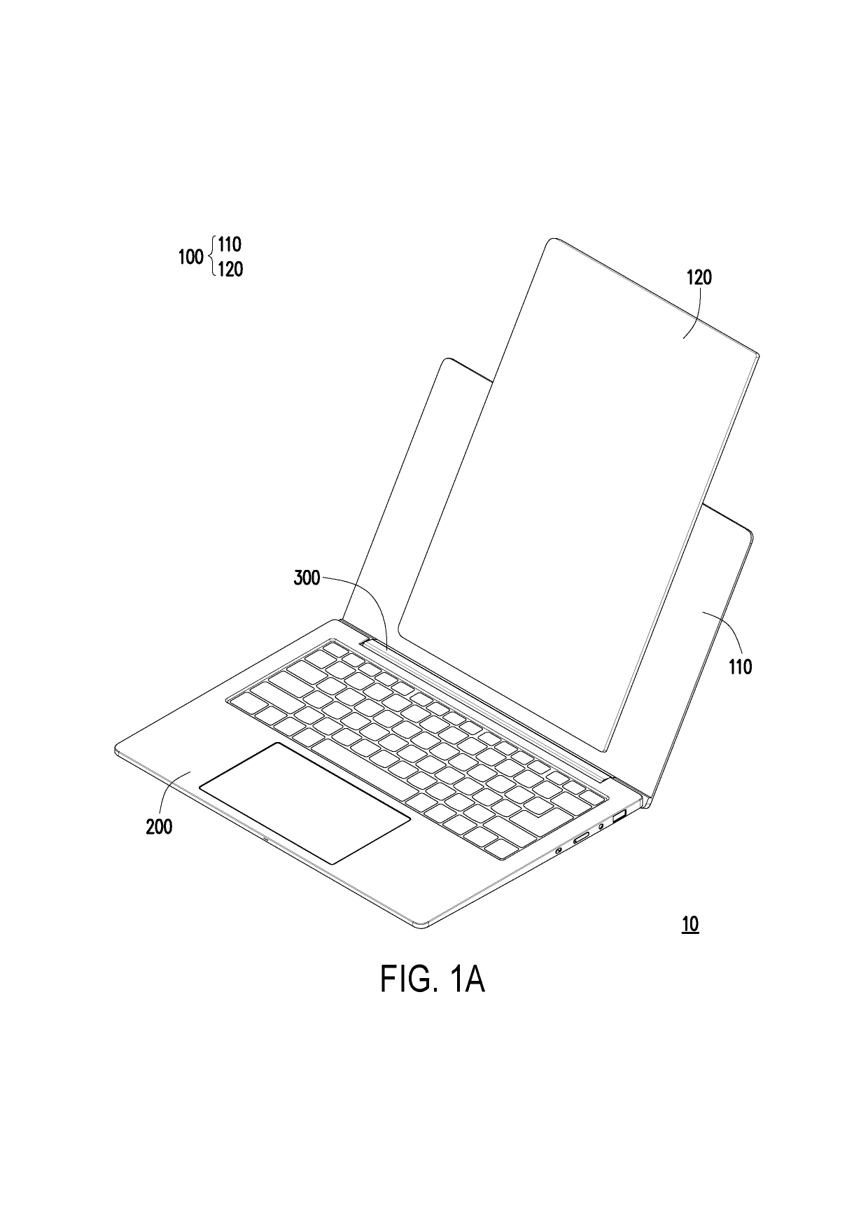

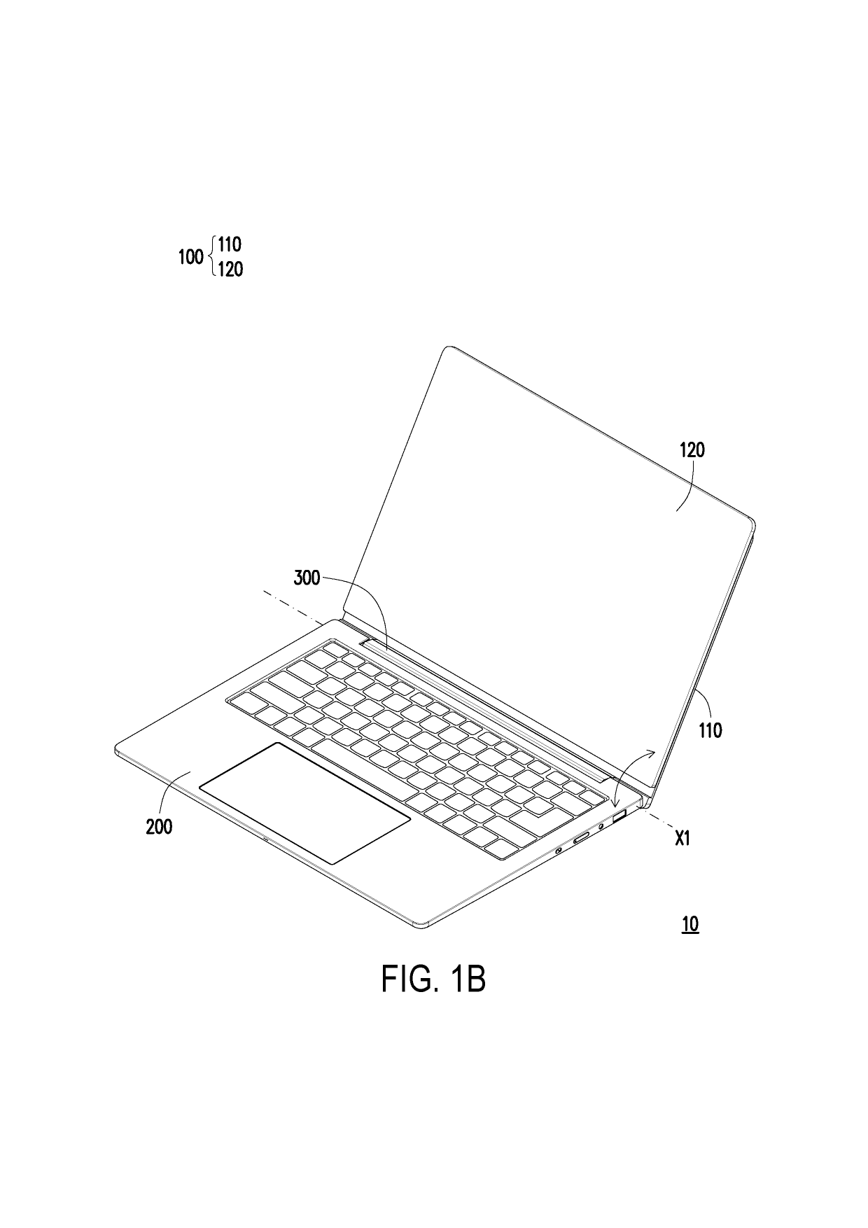

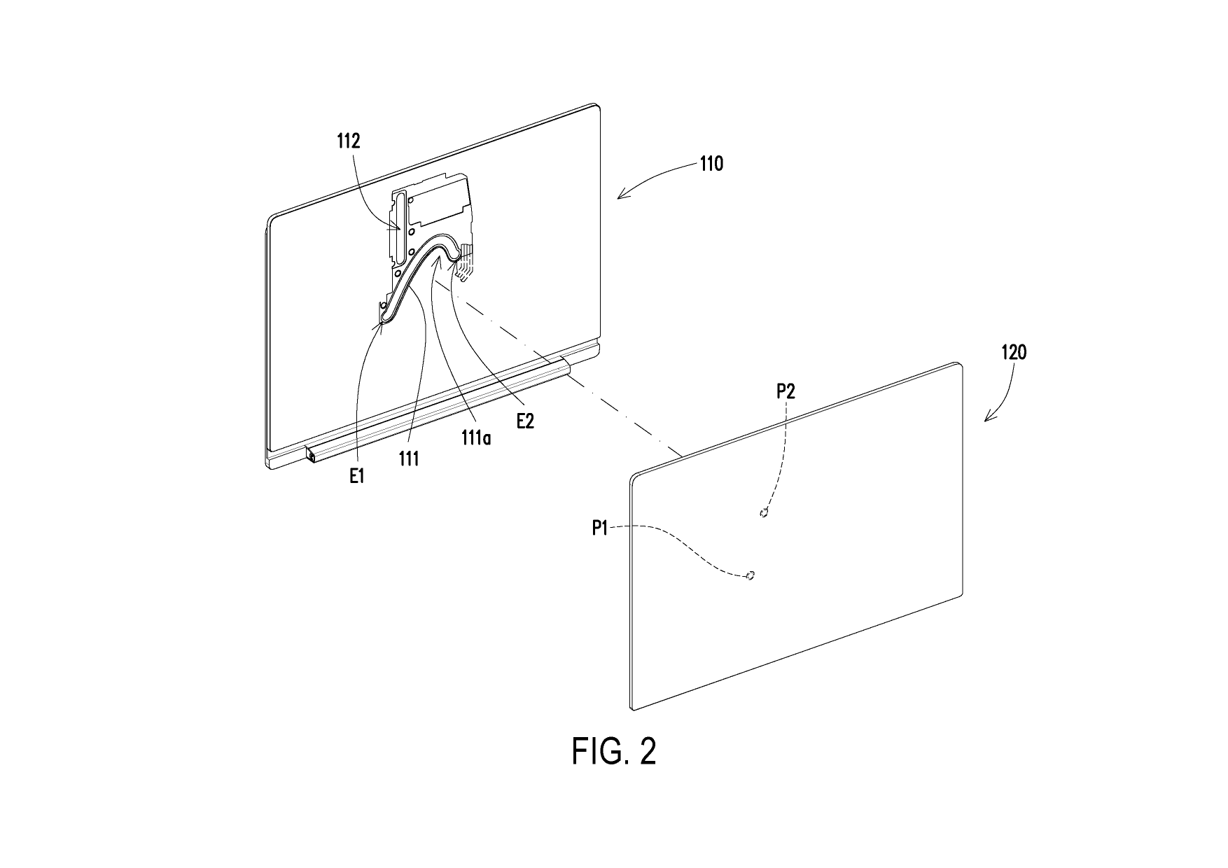

FIGS. 1A and 1B respectively illustrate different states of an electronic device of the disclosure. FIG. 2 is an exploded schematic diagram of some components of the electronic device. In this embodiment, the electronic device 10 is, for example, a conventional lap (not shown), and includes a display host 100, a logic host 200, and a hinge module 300. The hinge module 300 is connected between the display host 100 and the logic host 200 so that the display host 100 and the logic host 200 pivot relative to each other about an axis X1 via the hinge module 300 to fold and unfold. Referring to FIGS. 1A, 1B and 2 simultaneously, which illustrate another new type of laptop, the display host 100 further includes a base 110 and a screen 120. The base 110 is connected to the logic host 200 via the aforementioned hinge module 300, and the base 110 has a curved track 111 and a straight track 112. The screen 120 is pivotally and movably coupled to the curved track 111 via an axis P1, and is pivotally and movably coupled to the straight track 112 via an axis P2. In this new type of laptop, the screen 120 may rotate relative to the base 110 due to the aforementioned combination of axes and tracks, thereby switching between the landscape state shown in FIG. 1B and the portrait state shown in FIG. 1A. The position of the center of gravity of the display host 100 is markedly higher when it is in the portrait state than when it is in the landscape state. In summary, whether the laptop is of a conventional type or a new type, the hinge module 300 employed is required to provide an adjustable torque output; accordingly, the hinge module 300 of the disclosure is applicable in all such cases.

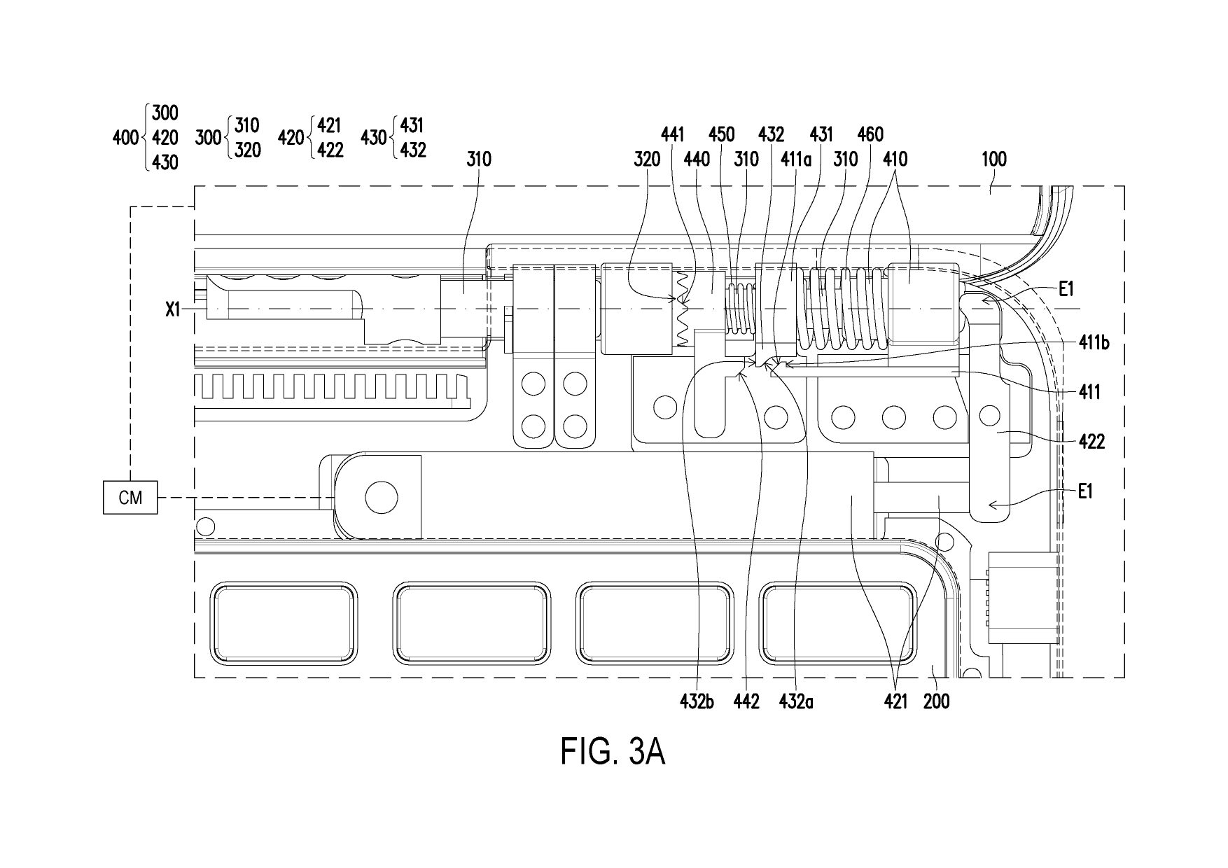

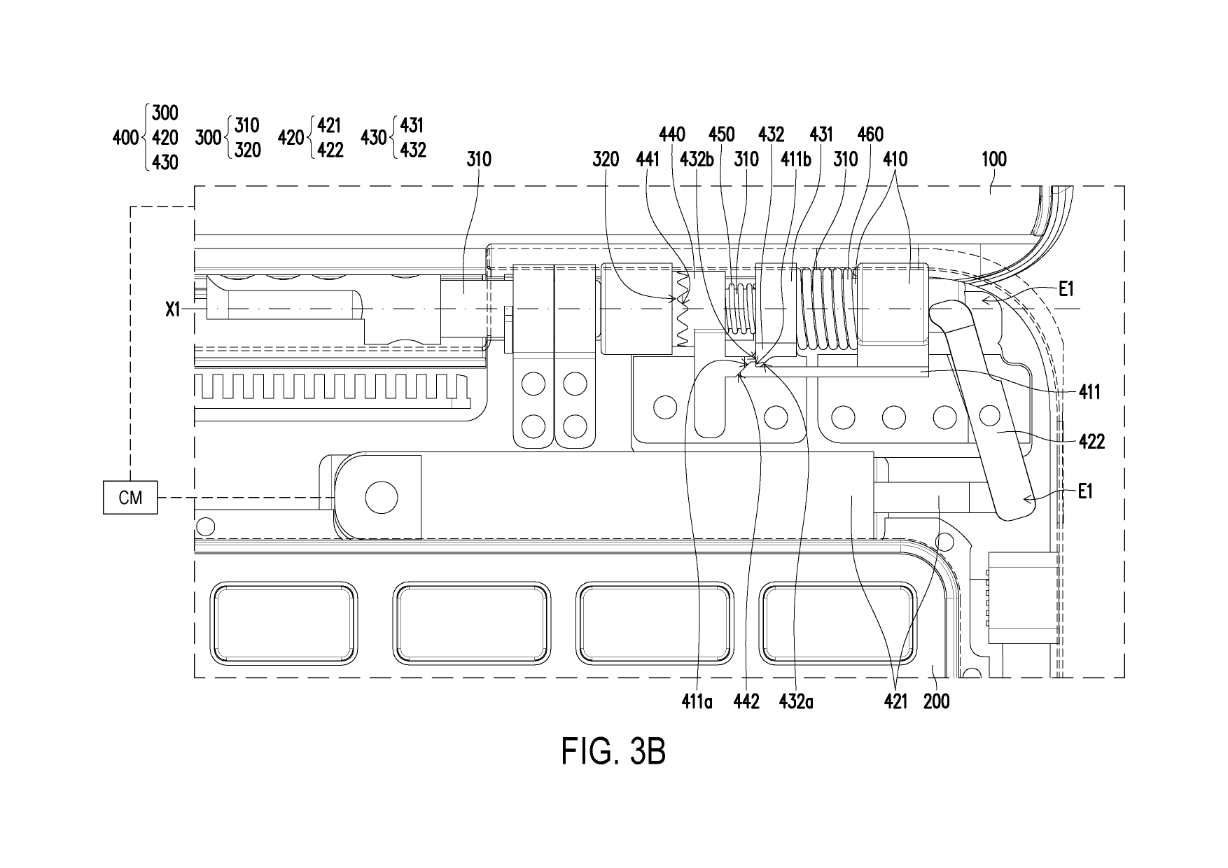

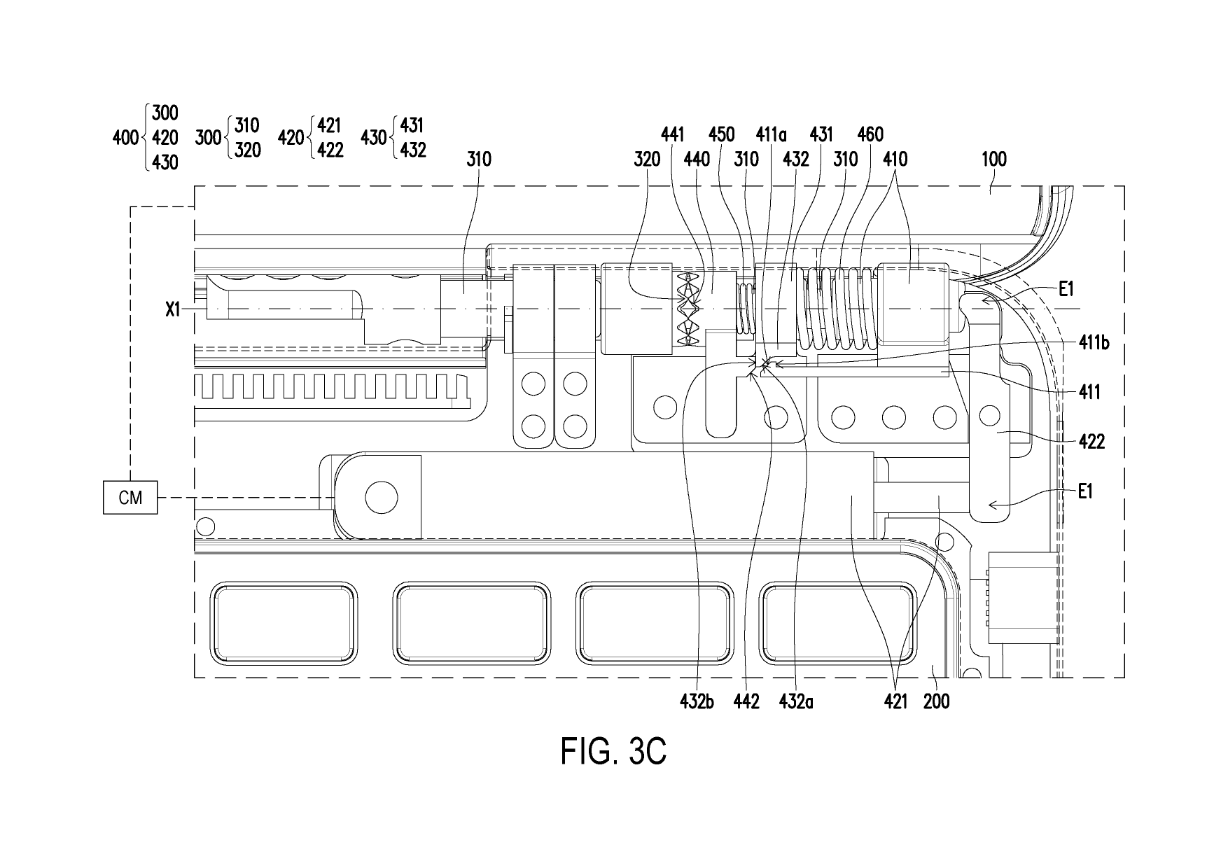

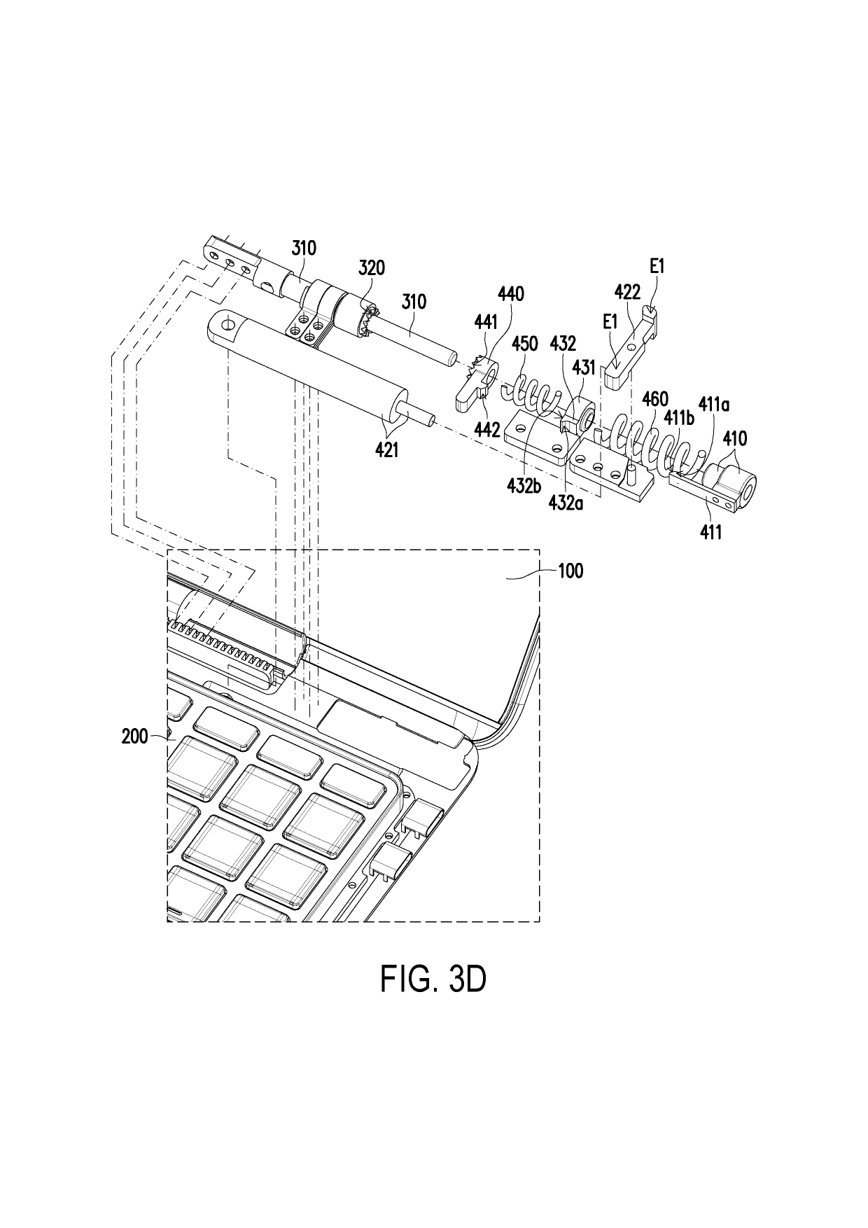

FIGS. 3A-3C respectively illustrate different states of a latching module. FIG. 3D is an exploded schematic diagram of the latching module. Referring to FIGS. 3A, 3B and 3D in this embodiment, to ensure that the hinge module 300 may remain operable by the user under low-torque conditions, such as the touch operation described in the foregoing prior art, or in the situation illustrated in FIG. 1A where rotation of the screen 120 to a portrait state elevates the center of gravity, thereby causing the hinge module 300 to have insufficient torque to provide support, the electronic device 10 in this embodiment further includes a latching module 400, which is movably assembled to the logic host 200 and connected to the hinge module 300 to lock or unlock the hinge module 300. When locked, the latching module 400 blocks the pivotal movement of the hinge module 300 about axis X1. When unlocked, the latching module 400 releases the hinge module 300 to allow the pivotal movement of the hinge module 300 about the axis X1. Here, FIG. 3A shows a "not yet locked" state of the latching module 400, FIG. 3B shows the locked state of the latching module 400, and FIG. 3C shows the unlocked state of the latching module 400. FIG. 3C is an intermediate state in the transition from FIGS. 3B-3A.

Furthermore, the logic host 200 includes a control module CM, which is electrically connected to the display host 100 and the latching module 400. When the display host 100 transitions from the first mode to the second mode and generates a triggering action, the control module CM senses the triggering action and drives the latching module 400 to lock the hinge module 300. When the display host 100 is closed toward the logic host 200 from the second mode to generate another triggering action, the latching module 400 releases the hinge module 300 and allows the display host 100 to continue pivotally closing toward the logic host 200.

Taking this embodiment as an example, the transition of the display host 100 includes two usage scenarios. One scenario is a transition between the states of the screen 120 as shown in FIGS. 1A and 1B. The portrait state shown in FIG. 1A may be regarded as the second mode, and the landscape state shown in FIG. 1B may be regarded as the first mode. The act of the user exerting force to the screen 120 to perform such transition is regarded as the triggering action. Another scenario is in the state shown in FIGS. 1A or 1B. Since the screen 120 of the display host 100 is a touch screen, in the first mode, the touch screen receives display signals from the control module CM, which is equivalent to the normal use state of a laptop. In the second mode, the touch screen receives display signals provided by the control module CM and the touch screen generates touch signals due to the triggering action, that is, the touch of the user on the screen 120 is regarded as a triggering action. It should be noted that the triggering conditions for the touch action are not limited to the embodiments of the new type of laptop shown in FIGS. 1A and 1B, but also apply to conventional laptops with touch screens.

The following embodiments illustrate the triggering action of the user. In this embodiment, the screen 120 of the display host 100 is a touch screen with a predetermined touch range. The user provides a touch action within the touch range, and the control module CM further analyzes the measurable characteristics of the touch action of the user, such as force, range, vector and duration. Once it is determined that the set activation threshold has been reached, the latching module 400 may be activated.

Referring to FIGS. 3A and 3D, the latching module 400 in this embodiment includes a clutch 410 and a drive assembly 420. The clutch 410 is movably sleeved on the shaft 310 of the hinge module 300, and the drive assembly 420 is movably disposed next to the clutch 410 so that the clutch 410 is located within the range of motion of the drive assembly 420. The aforementioned triggering action causes the drive assembly 420 to drive the clutch 410 to abut against the shaft 310, thereby preventing the shaft 310 from rotating about the axis X1.

Furthermore, the drive assembly 420 of this embodiment includes an electric push rod 421 and a lever 422. The electric push rod 421 is disposed in the logic host 200 and is electrically connected to the control module CM. The lever 422 is pivotally disposed in the logic host 200. The lever 422 has a first end E1 and a second end E2 located at opposite pivot points. The first end E1 is connected to the electric push rod 421, and the second end E2 is connected to the clutch 410.

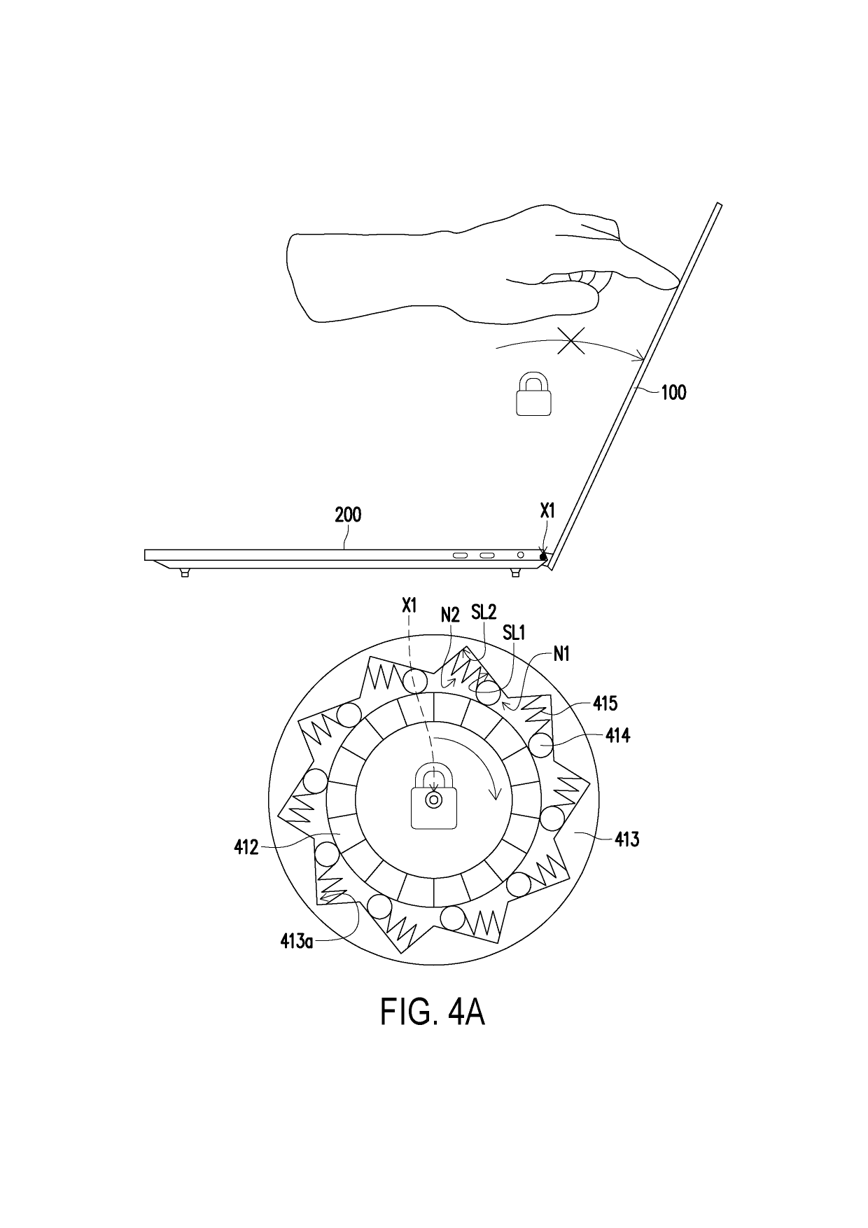

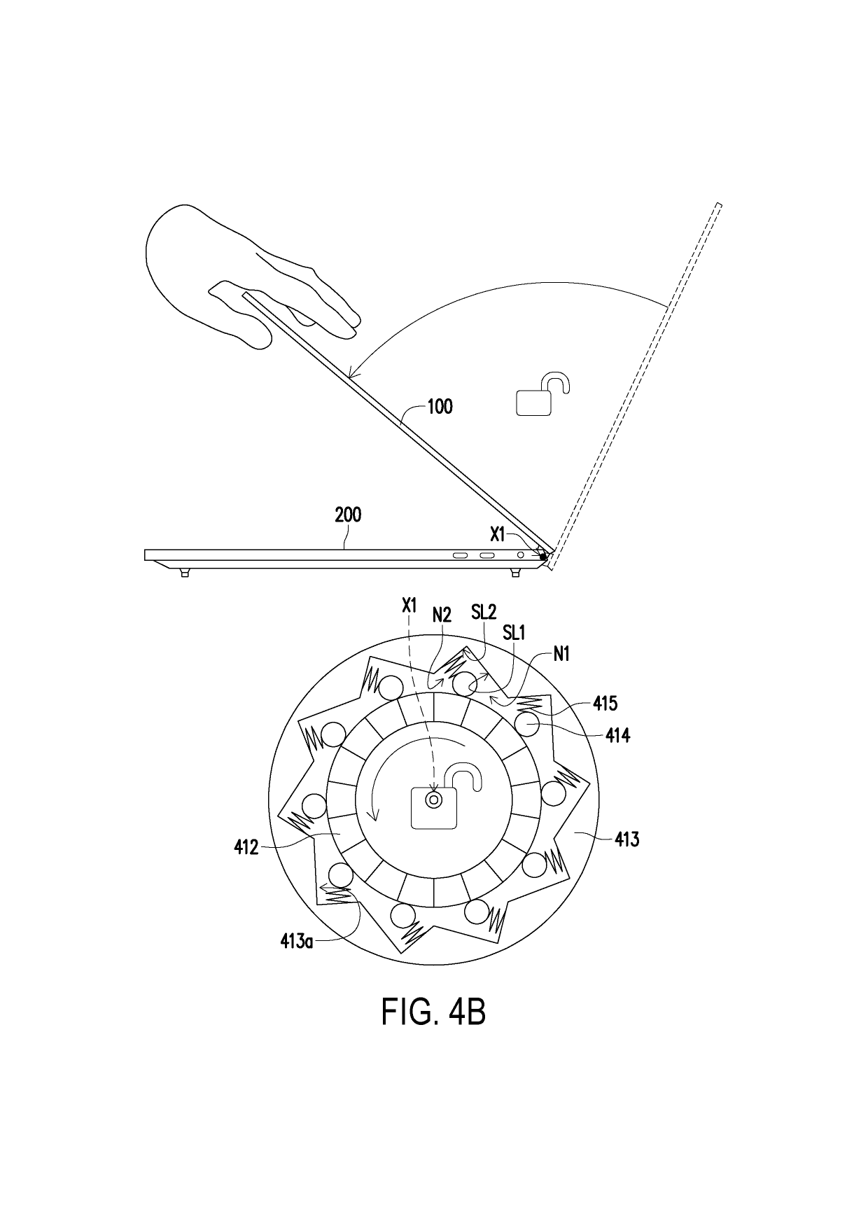

FIGS. 4A and 4B respectively illustrate the corresponding states of a clutch and the electronic device. Referring to FIGS. 4A and 4B, in this embodiment, the main structure of the clutch 410 is, for example, a one-way bearing, which serves as the mating member of the shaft 310, and the rotation axis of the one-way bearing is consistent with the axis X1 of the hinge module 300. The one-way bearing includes an inner ring 412 and an outer ring 413 with a sloping groove 413a, as well as a roller 414 and a spring 415 located between the inner ring 412 and the outer ring 413. The sloping groove 413a has a long slope SL1 and a short slope SL2 with different orientations. The spring 415 is connected to the short slope SL2, and the roller 414 is connected to the spring 415. Accordingly, as shown in FIG. 4A, when the rotation direction of the one-way bearing drives the roller 414 to move toward the narrow portion N1 of the sloping groove 413a, the roller 414 is stuck (wedged) between the inner ring 412 and the outer ring 413, thereby coupling the inner ring 412 and the outer ring 413 as a unit to rotate in unison. Conversely, as shown in 4B, when the rotation direction of the one-way bearing drives the roller 414 to move towards the wide portion N2 of the sloped groove 413a, a gap is maintained between the inner ring 412 and the outer ring 413, so the inner ring 412 and the outer ring 413 are free to rotate relative to one another. Accordingly, when locked, the latching module 400 causes the inner ring 412 of the clutch 410 to abut against the shaft 310, thus restricting the shaft 310 to rotate only in one direction. Conversely, it causes the inner ring 412 to move away from the shaft 310.

In another embodiment not shown, the structures of the inner ring 412 and the outer ring 413 may be interchanged.

Referring to FIGS. 3A and 3D again, the latching module 400 in this embodiment also includes a stopper 430 fixedly disposed within the logic host 200 and having a ring 431 and a stop portion 432. The ring 431 is configured to allow the shaft 310 to pass through. The clutch 410 has a spring arm 411. The end of the spring arm 411 has a first inclined surface 411a and a hook portion 411b that are facing away from each other. The stop portion 432 of the stopper 430 protrudes from the outer ring surface of the ring 431 and is located within the range of motion of the end of the spring arm 411. The stop portion 432 has a second inclined surface 432a and a stop wall 432b that are facing away from each other.

Furthermore, the latching module 400 also includes an unlocking member 440, which is sleeved on the shaft 310 and movably located along the shaft 310 between the first ring toothed portion 320 and the stopper 430 of the hinge module 300. The first ring toothed portion 320 is fixedly disposed on the shaft 310 and circumferentially surrounds the shaft 310. The unlocking member 440 has a second ring toothed portion 441 to engage with the first ring toothed portion 320 or to move away from the first ring toothed portion 320. The latching module 400 also includes a first elastic member 450, which is sleeved on the shaft 310 and is disposed in abutment between the unlocking member 440 and the stopper 430. The elastic force of the first elastic member 450 constantly drives the second ring toothed portion 441 of the unlocking member 440 to engage with the first ring toothed portion 320. The latching module 400 also includes a second elastic member 460, which is sleeved on the shaft 310 and is disposed in abutment between the stopper 430 and the clutch 410. The second elastic member 460 constantly drives the clutch 410 to move away from the stopper 430 to release the shaft 310.

Referring to FIGS. 3A and 3B, based on the above-mentioned corresponding configuration of the latching module 400 relative to the hinge module 300, in response to the aforementioned triggering action and during execution of the locking process, the electric push rod 421 is driven by the control module CM to push and rotate the lever 422, causing the lever 422 to drive the clutch 410 to abut against the shaft 310, that is, the process shown in the transition from FIGS. 3A-3B. During a process in which the clutch 410 abuts against the shaft 310, the end of the spring arm 411 moves towards the stop portion 432. As the first inclined surface 411a abuts against the second inclined surface 432a, the spring arm 411 is deformed until the end of the spring arm 411 passes beyond the stop portion 432, whereupon the spring arm 411 returns to its original position and the hook portion 411b is latched to the stop wall 432b due to the elastic force of the second elastic member 460. At this point, the locking action is completed. Since the hook 411b of the spring arm 411 is latched to the stop wall 432b to maintain the position of the clutch 410, the shaft 310 may continuously abut against the clutch 410. At this time, the shaft 310 cannot continue to pivot in the unfolding direction relative to the logic host 200 due to the limitation of the one-way bearing. However, the shaft 310 may still drive the display host 100 to pivot relative to the logic host 200 in the folding/closing direction. At the same time, the second elastic member 460 is deformed by pressure as the clutch 410 moves closer to the stopper 430.

It should be noted that, depending on the usage requirements, in other embodiments, the clutch 410, serving as a one-way bearing, has an upper limit on the limiting force on the shaft 310. That is, when the force applied by the user to the display host 100 exceeds the upper limit, the display host 100 may still be driven to rotate relative to the logic host 200 in the unfolding direction, thereby preventing damage to the relevant components resulting from excessive user-applied force.

Referring to FIGS. 3B and 3C, when the user provides another triggering action, the latching module 400 may be driven to unlock the hinge module 300. Here, the other triggering action could be that the user drives the shaft 310 to rotate, causing the display host 100 to pivot relative to the logic host 200 in the folding direction, or it could be the aforementioned change from a portrait state to a landscape state, but here we take the former as an example. Accordingly, as shown in the process of transitioning from FIGS. 3B-3C, the shaft 310 rotates so that the first ring toothed portion 320 drives the second ring toothed portion 441 to separate from each other and drives the unlocking member 440 to move toward the stopper 430 and deform the first elastic member 450. During the process in which the unlocking member 440 moves toward the stopper 430, in addition to subjecting the first elastic member 450 to compressive deformation, a third inclined surface 442 of the unlocking member 440 abuttingly pushes the first inclined surface 411a so as to deform the spring arm 411, whereby the hook portion 411b separates from the stop wall 432b until the end of the spring arm 411 passes beyond the stop portion 432 and releases the latching relationship with the stop portion 432, as shown in FIG. 3B. At the same time, the clutch 410 is moved away and the shaft 310 is released. Next, upon the separation of the hook portion 411b from the stop portion 432, the clutch 410 returns to the original position by means of the elastic force of the second elastic member 460, and the unlocking member 440 returns to the original position by means of the elastic force of the first elastic member 450 (so that the second ring toothed portion 441 re-engages with the first ring toothed portion 320), so that the latching module 400 is restored from the state shown in FIG. 3C to the state shown in FIG. 3A.

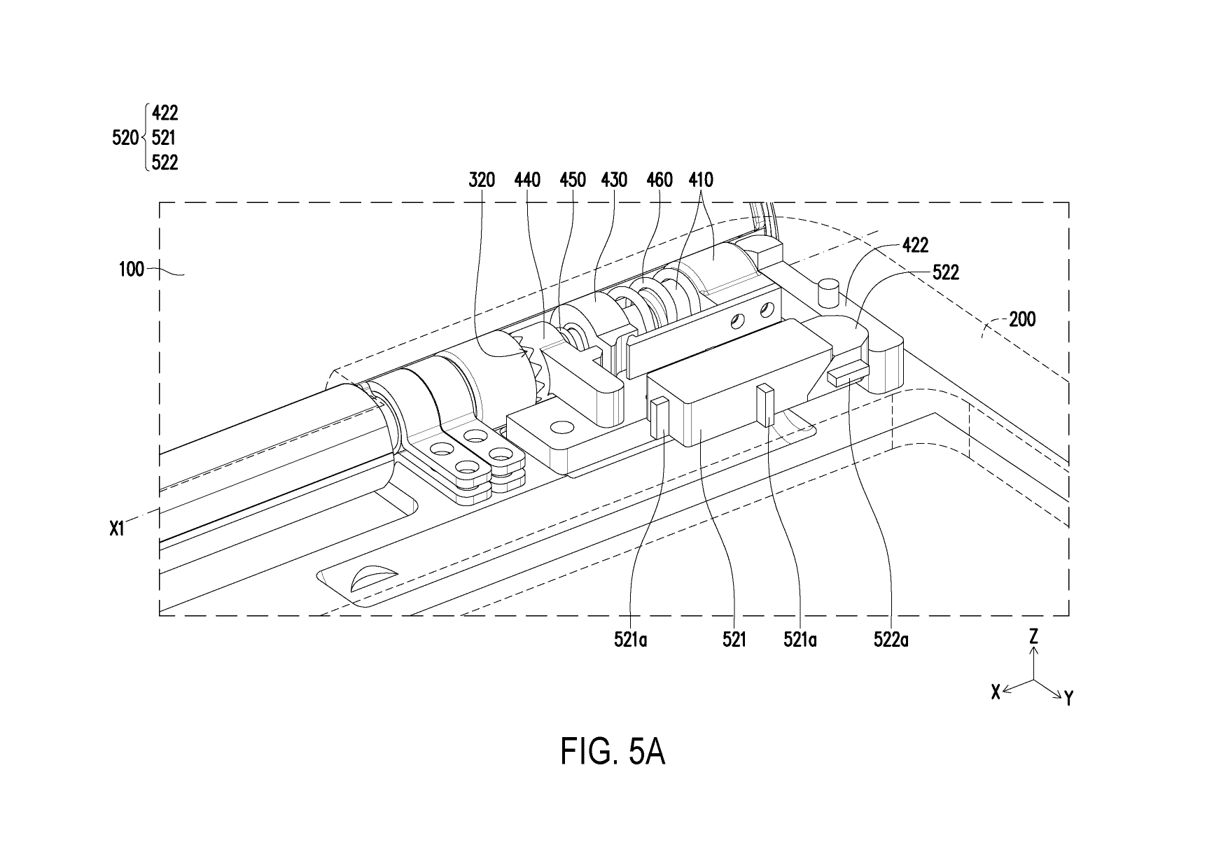

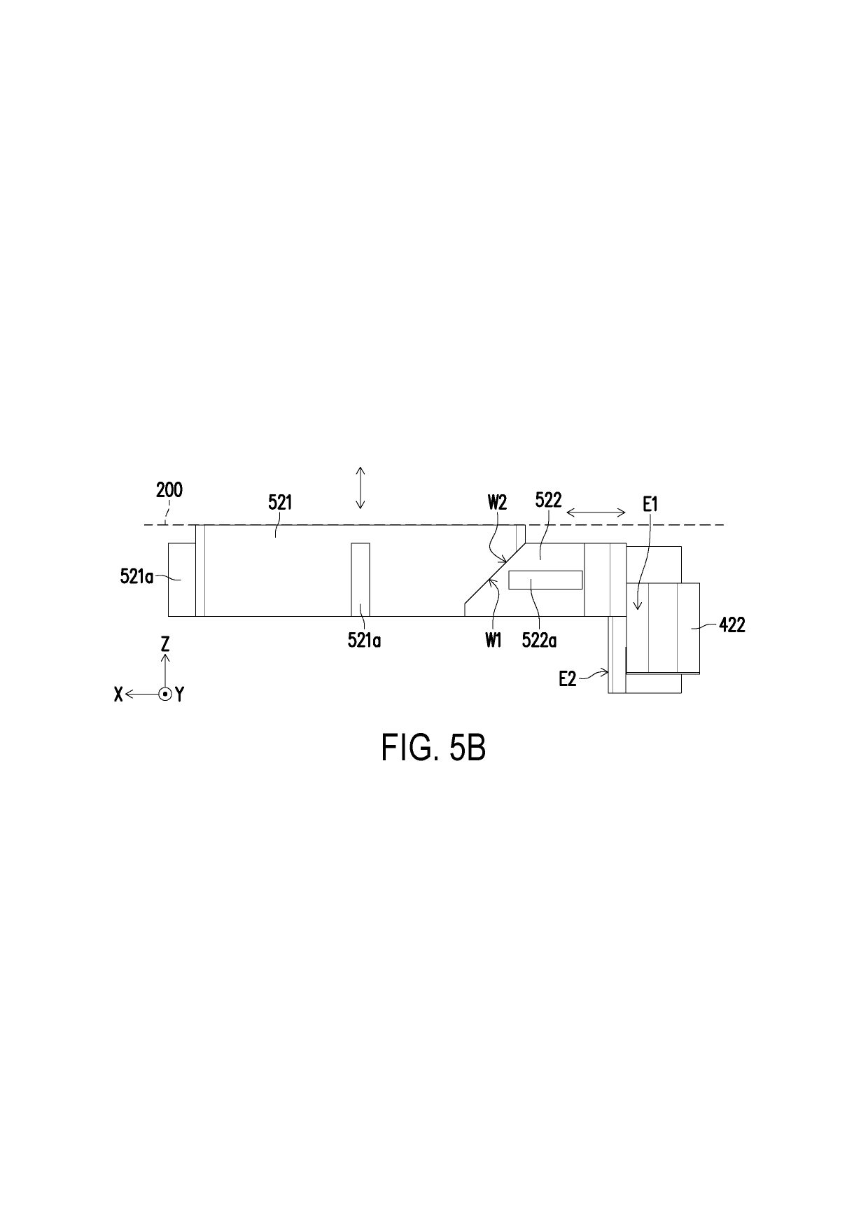

FIG. 5A is a schematic diagram of a latching module of another embodiment of the disclosure. FIG. 5B illustrates some components of FIG. 5A from another perspective. Cartesian coordinates X-Y-Z are provided here to facilitate component description. Referring to FIGS. 5A and 5B simultaneously, the difference from the previous embodiments is that the drive assembly 520 in this embodiment includes a physical button and a lever 422. The physical button includes a button 521 and a slider 522. The button 521 is disposed in the logic host 200 so as to be movable up and down along a Z-axis and is partially exposed from the logic host 200. The slider 522 is movably disposed within the logic host 200 along an X-axis. The button 521 and the slider 522 abut against each other through wedge surfaces W1 and W2, thereby converting an up-and-down movement of the button 521 along the Z-axis into a lateral displacement of the slider 522 along the X-axis. Here, the aforementioned pivot axis (axis X1) of the display host 100 relative to the logic host 200 is substantially parallel to or coincides with the X-axis. The lever 422 is pivotally disposed in the logic host 200. The lever 422 has a first end E1 and a second end E2 located at opposite pivot points. The first end E1 is connected to the slider 522, and the second end E2 is connected to the clutch 410. In this way, this embodiment provides users with a physical button on the logic host 200 for operation to achieve the same effect as the aforementioned embodiments. The state of the physical button also allows users to identify the current locked or unlocked state of the latching module 500.

In other embodiments not shown, physical buttons may also be used to notify the control module CM to drive the electric push rod 421. In the embodiments of FIGS. 5A and 5B, the physical button may also be replaced by an existing specific button on the logic host 200, or a combination thereof.

To sum up, in the above embodiments of this disclosure, the electronic device provides different driving modes for locking or unlocking the hinge module through a latching module disposed in the logic host and connected to the hinge module. When locked, the latching module blocks pivoting of the hinge module. When unlocked, the latching module releases the hinge module, allowing the display host and logic host to pivot relative to each other via the hinge module to fold and unfold. The aforementioned driving modes are executed by an externally triggering action after the display host unfolds relative to the logic host.

Furthermore, for the display host, the rotation of its screen relative to the base during the transition between a landscape state and a portrait state may be regarded as the aforementioned triggering action. In another embodiment, the display host is a touch screen; accordingly, the touch action of user on the screen that satisfies a predetermined determination condition may be deemed a triggering action. Furthermore, the purpose of the aforementioned triggering action is to lock the hinge module so that the hinge module has sufficient torque to support the display host and facilitate touch operation on the display host by a user. Accordingly, when the display host is closed by the user, the latching module may be unlocked and the hinge module may be released. Furthermore, when the user applies a force greater than a predetermined value to the display host, the display host may continue to unfold relative to the logic host, thereby preventing damage to related components and improving the operating characteristics of the electronic device.

Accordingly, users may adjust the locked or unlocked state of the hinge module according to their usage requirements without worrying about the risks that may arise with locking.

What is claimed is:

1. An electronic device, comprising:
a display host;
a logic host;
a hinge module, connected between the display host and the logic host, wherein the display host and the logic host pivot relative to each other via the hinge module to fold and unfold; and
a latching module, movably assembled to the logic host and connected to the hinge module to lock or unlock the hinge module,
wherein, when locked, the latching module blocks pivoting of the hinge module, when unlocked, the latching module releases the hinge module to allow the hinge module to pivot,
wherein the electronic device is driven by a triggering action to drive the latching module to lock the hinge module or release the hinge module after the display host pivots relative to the logic host via the hinge module to unfold.

2. The electronic device according to claim 1, wherein the logic host comprises a control module electrically connected to the display host and the latching module, when the display host transitions from a first mode to a second mode and generates the triggering action, the control module senses the triggering action and drives the latching module to lock the hinge module, when the display host is closed toward the logic host from the second mode to generate another triggering action, the latching module releases the hinge module and allows the display host to continue pivotally closing toward the logic host.

3. The electronic device according to claim 2, wherein the display host further comprises a base and a screen, the base is connected to the logic host via the hinge module, the control module is electrically connected to the screen, the screen and the base are coupled parallel to each other, so that the screen switches between the first mode and the second mode relative to the base, in the first mode, the screen is in a landscape state relative to the base, in the second mode, the screen is in a portrait state relative to the base.

4. The electronic device according to claim 2, wherein the display host is a touch screen, in the first mode, the touch screen receives a display signal from the control module, in the second mode, the touch screen receives the display signal provided by the control module and the touch screen generates a touch signal due to the triggering action.

5. The electronic device according to claim 1, wherein the latching module comprises:
a clutch, movably sleeved on a shaft of the hinge module; and
a drive assembly, movably disposed next to the clutch so that the clutch is located within a range of motion of the drive assembly, the triggering action causes the drive assembly to drive the clutch to abut against the shaft to prevent the shaft from rotating.

6. The electronic device according to claim 5, wherein the drive assembly comprises an electric push rod and a lever, the electric push rod is disposed in the logic host, the lever is pivotally disposed in the logic host, the lever has a first end and a second end located at opposite pivot points, the first end is connected to the electric push rod, the second end is connected to the clutch.

7. The electronic device according to claim 6, wherein the logic host comprises a control module electrically connected to the display host and the electric push rod.

8. The electronic device according to claim 5, wherein the drive assembly comprises a physical button and a lever disposed on an exterior of the electronic device, the physical button is movably disposed in the logic host and is partially exposed from the logic host, the lever is pivotally disposed in the logic host, the lever has a first end and a second end located at opposite pivot points, the first end is connected to the physical button, and the second end is connected to the clutch.

9. The electronic device according to claim 5, wherein the latching module further comprises a stopper disposed within the logic host, the clutch has a spring arm, an end of the spring arm has a first inclined surface and a hook portion that are facing away from each other, a stop portion of the stopper is located within a range of motion of the end of the spring arm, and the stop portion has a second inclined surface and a stop wall that are facing away from each other, during a process in which the clutch abuts against the shaft, the end of the spring arm moves towards the stop portion, the first inclined surface abuts against the second inclined to deform the spring arm, until the end of the spring arm passes beyond the stop portion, whereupon the spring arm returns to an original position and the hook portion is latched to the stop wall.

10. The electronic device according to claim 9, wherein the latching module further comprises an unlocking member sleeved on the shaft and movably located along the shaft between a first ring toothed portion and the stopper of the hinge module, the first ring toothed portion is fixedly disposed on the shaft and circumferentially surrounds the shaft, the unlocking member has a second ring toothed portion to engage with the first ring toothed portion or to move away from the first ring toothed portion, when the second ring toothed portion separates from the first ring toothed portion, a third inclined surface of the unlocking member abuttingly pushes the first inclined surface to deform the spring arm and the hook portion separates from the stop wall.

11. The electronic device according to claim 10, wherein the latching module further comprises a first elastic member sleeved on the shaft and disposed in abutment between the unlocking member and the stopper, an elastic force of the first elastic member constantly drives the second ring toothed portion of the unlocking member to engage with the first ring toothed portion, after the display host and the logic host have been unfolded relative to each other, when the display host is closed toward the logic host, the shaft rotates so that the first ring toothed portion drives the second ring toothed portion separate from each other and drives the unlocking member to move toward the stopper and deform the first elastic member.

12. The electronic device according to claim 9, wherein the latching module further comprises a second elastic member sleeved on the shaft and disposed in abutment between the stopper and the clutch, the second elastic member constantly drives the clutch to move away from the stopper and release the shaft, when the clutch abuts against the shaft, the clutch deforms the spring arm, when the hook portion separates from the stop wall, the second elastic member drives the clutch to return to an original position.
